(19) United States
(12) Patent Application Publication
(10) Pub. No.: US 2015/0059821 A1
(43) Pub. Date: Mar. 5, 2015

(54) Device for the Conversion of Nuclear Waste Radiation to Electrical Current

(71) Applicant: Robert Samuel Altomare, Oviedo, FL (US)

(72) Inventor: Robert Samuel Altomare, Oviedo, FL (US)

(21) Appl. No.: 13/939,236

(22) Filed: Aug. 29, 2013

(51) Int. Cl. G21H 1/12

(52) U.S. Cl. CPC G21H 1/12
USPC 136/244

(57) ABSTRACT

A device for passively converting nuclear radiation to electricity comprising a plurality of thin-film flexible solar panels, sandwiched between a plurality of diagnostic intensifying screens by which conversion of radiation to light and subsequently to electrical current through the sandwiched thin-film flexible solar panels is effected. The layered array will be comprised of one layer of intensifying screen material affixed to one layer of thin-film flexible solar panels with repeated layers for a total of three intensifying screen-solar panel pairs. This device makes use of new flexible solar panel design and efficiencies. Through the flexible nature provided by both components (intensifying screen and thin film solar panels), facilitates the complete wrapped envelopment of High Level Nuclear Waste containment cylinders and can accommodate any size and shape requirements.

### SPECIFICATION

This patent refers to Provisional Patent No. 61/674,364 filed Jun. 22, 2011. A device for passively converting nuclear radiation to electricity comprising a layered blanket, a plurality of thin-film flexible solar panels, sandwiched between a plurality of radiological diagnostic intensifying screens by which conversion of radiation to electricity by the sandwiched thin-film flexible solar panels is effected. The layered blanket will be comprised of one layer of intensifying screen material affixed to one layer of thin-film flexible solar panels with repeated layers for a total of three intensifying screen-solar panel pairs.

This invention resides in a device for converting waste nuclear energy to electricity comprising a layered array of alternating layers of diagnostic, light-emitting intensifying screens currently in use in diagnostic x-ray emitters affixed directly to a plurality of thin-film solar cell panels. Said layered array is further contained within a flexible sheath and patterned in such a way so as to facilitate the complete envelopment of a vitrified cylinder containing High Level Nuclear Waste materials, as is the current method of containing High Level Nuclear Waste therein. The emitted radiation from the contained High Level Nuclear Waste excites the diagnostic intensifying screens to fluoresce, wherein the emitted photons impinge on the affixed solar panels, thereby generating electricity.

### CROSS-REFERENCE TO RELATED APPLICATIONS

Provisional Patent Reference No.: 61/674,364

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX (IF APPLICABLE)

N/A

### BACKGROUND OF THE INVENTION

This invention pertains specifically to the passive generation of electrical current through the conversion of X-ray and Gamma Ray radiation that is present in High Level Nuclear Waste materials. The prior art, as exemplified by U.S. Pat. Nos. 3,999,057; 3,996,493; 3,564,234; 3,510,645; 3,833,828; 3,775,609; 3,497,392; 3,483,040; 3,351,516; 3,591,420; 3,751,303 and 3,857,036 is generally illustrative of the pertinent art but the aforementioned patents are non-applicable to the present invention. While the prior art expedients are generally acceptable for their intended purposes only, they have not proven entirely satisfactory in that they are either complex and expensive to manufacture or are not readily applicable within the current state of the art in high level nuclear waste storage modalities. As a result of the shortcomings of the prior art, typified by the above, there has developed a substantial need for improvement in this field.

Additionally, the prior art, as exemplified by U.S. Pat. No. 4,242,147 is generally illustrative of the pertinent art but the aforementioned patent is non-applicable to the present invention. While the aforementioned prior art is generally acceptable for its intended use, it does not account for real world design of High Level Nuclear Waste Storage regimes typified by a vitrified cylinder which is then further placed within a large cement cask. This storage regime represents the current means of storing high level nuclear waste and is considered the state of the art for nuclear waste handling. Furthermore, the prior art, as exemplified by U.S. Pat. No. 4,242,147 does not make use of advances in solar cell technology, principally among them, the flexible, thin-film solar cell panel. This advance in photovoltaic design allows for the total envelopment of the vitrified cylinder within the concrete cask and allows the device to become an integral component of the current storage regime with no re-engineering required.

The principal object of this invention is to provide a device or article of readily merchandisable character and combines simplicity, strength and durability in a high degree, together with inexpensiveness of construction so as to encourage widespread use thereof.

Additional objects and advantages of the invention will be set forth in part in the description which follows and in part will be obvious from the description, or may be realized by practice of the invention, the objects and advantages being realized and attained by means of the instrumentalities and combinations particularly pointed out in the appended claims.

### BRIEF SUMMARY OF THE INVENTION

This invention resides in a device for converting waste nuclear radiation to electricity by conversion of x-ray and gamma ray radiation to visible light and subsequently to electrical energy. The device is comprised of a layered array of alternating layers of diagnostic, light-emitting intensifying screens currently in use in diagnostic x-ray emitters affixed directly to a plurality of thin-film solar cell panels. Said layered array is further contained within a flexible sheath and shaped in such a way so as to facilitate the complete envelopment of a cylindrical container of vitrified nuclear waste as is the current method of storing High Level Nuclear Waste therein.

### BRIEF DESCRIPTION OF THE SEVERAL VIEWS OF THE DRAWING

FIG. 1 depicts a perspective, exploded view of the device (D) and depicts the manner in which the device is wrapped around the outer surface of a vitrified cylinder (A) containing the High Level Nuclear Waste within same.

FIG. 1 depicts a perspective, exploded view of the device (D) and depicts the layers comprised of Thin Film Solar Panels (B) and Diagnostic Intensifying Screens (C).

FIG. 1 depicts a semi exploded view (D) demonstrating the layering of the diagnostic intensifying screens (C) as they are layered and paired with thin film solar panels (B) as the device surrounds the vitrified cylinder (A).

FIG. 2 depicts a top view of the High Level Nuclear Waste vitrified cylinder (A) completely wrapped by the device (D).

FIG. 3 depicts a close up top view of the High Level Nuclear Waste vitrified cylinder (A) completely wrapped by device (D) and demonstrates the combination of alternating layers of intensifying screen and thin film solar panels (E).

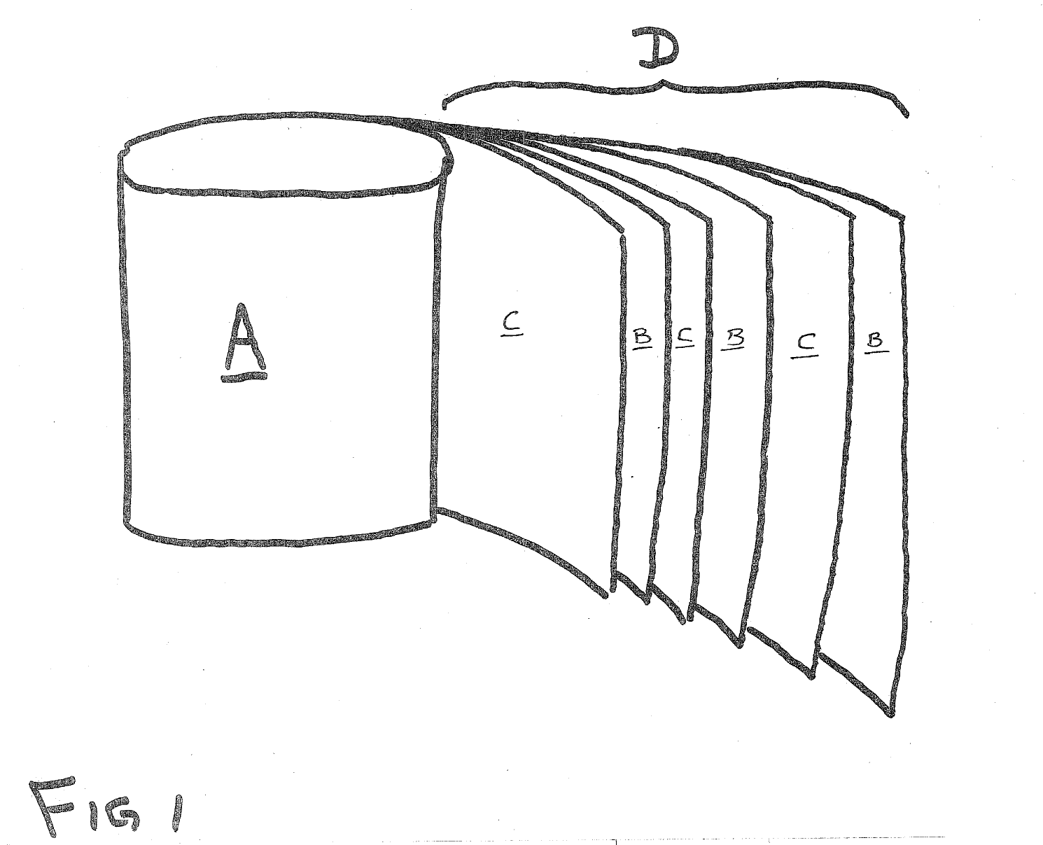

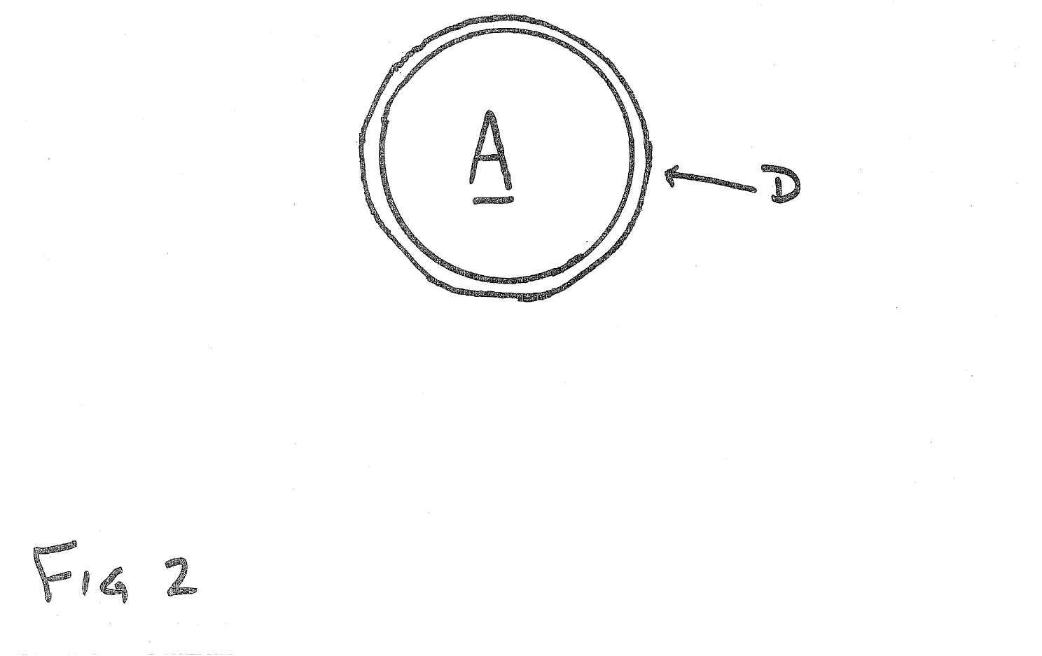

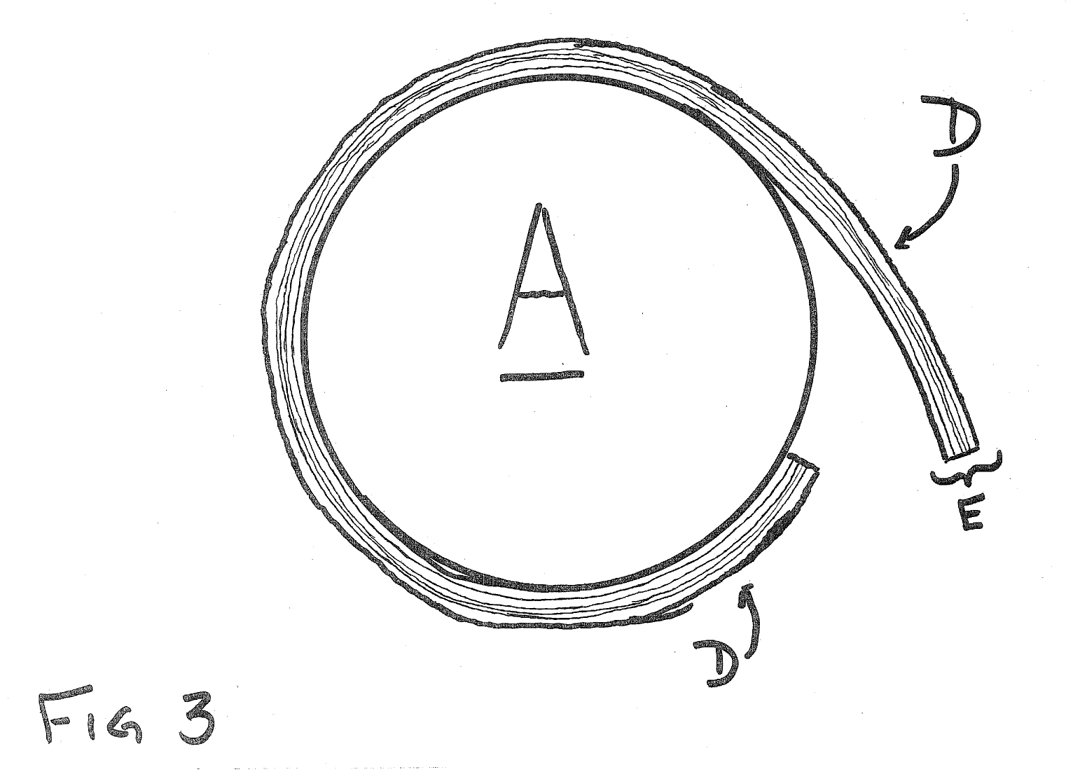

### DETAILED DESCRIPTION OF THE INVENTION

The tangible embodiment of the invention includes layers comprised of diagnostic intensifying screens permanently affixed to thin-film flexible solar cells for a total of three matched pairs of intensifying screen and thin film solar panel, further encased in a flexible casing of polyester. This is then patterned, cut and designed to fit over and completely envelop the vitrified cylinder containing said High Level Nuclear Waste within the concrete high level waste cask.

The light emitting intensifying screens, which by definition are coated with phosphorescent crystals, are affixed to each thin-film solar panel. The radioactive waste material held within the vitrified cylinder excites the phosphorescent or fluorescent crystals contained on the intensifying screens through natural radiation of x-rays and gamma rays. The phosphorescent materials thus emit photons of light which impinge on the directly affixed photocells thereby creating current.

Silicon solar type cells are made of two types of semiconductor silicon. One type has an added small number of boron atoms to provide a slight positive electronic charge. This is called “p” or positively doped silicon. The other, “n” type, negatively doped silicon, has added phosphorus or arsenic atoms. When these two types of silicon meet in a wafer, or solar electric cell, a “P-N” junction is formed with an electronic charge imbalance between the two layers.

Across this “P-N” junction, a basic polarity difference or voltage potential develops. The extra electrons from the phosphorus doped “n-type” silicon move to the boron atoms in the “p-type” silicon, where they fill an open place or “hole” in a boron electron band. This leaves the “n-type” silicon with a slight positive charge and the “p-type” with a slight negative charge.

When light shines on a cell junction, small packets of light called photons strike the atoms in the photocell, exciting electrons in the atoms to escape the strong pull of the protons in the nuclei. These liberated electrons move toward the positively charged “n-type” silicon and later out into the circuit wire to the pump, light, motor or other load which uses the electrical power. As with any electrical circuit, the loop must be completed back to the “p-type” silicon for the electrons to return to their starting place, with the circuit loop being completed by the external electrical load (not shown) connected to switch gear 41.

In this way, a portion of the energy in light is converted into the movement of electrons around a circuit. Since light is made up of photons of various energies (corresponding to the various colors of the sunlight spectrum) and one photon can only excite and liberate one electron, the energy in a particular photon above that needed to liberate the electron is left over as heat. The electrical efficiency of a solar cell is the measure of electrical energy converted, as compared to the input energy that reached the cell. Current production methods yield silicon solar cells which exhibit efficiencies between 15% and 19%. Laboratory methods have produced 40% to 42% efficient cells out of a maximum expected, or theoretical, limit of 86%.

All silicon solar type cells develop a voltage of about 0.45 volts per cell, regardless of size, with the maximum current varying according to manufacturing method and cell surface area. For a three inch diameter circular cell, current output ranges from 500 milliamperes to 1.2 amperes or more. This output is direct current similar to that from a battery. The current output from a cell will increase from zero in the dark to its maximum at about 100 milliwatts per square centimeter solar illumination. The voltage is dependent on cell temperature; it drops a small amount for each degree above a specified test temperature.

The individual photocells contained within the layered array are electrically joined and connected together in a series configuration so as to collectively produce a higher voltage than that of an individual cell and several such arrays from several such high level nuclear waste storage casks may be connected in parallel so as to produce a greater current flow than that of an individual array and an individual storage cask.

The operation and use of the invention hereinabove described will be evident to those skilled in the art to which it relates from a consideration of the foregoing.

The present invention is believed to accomplish among others all of the objects and advantages herein set forth. This invention advances the use of radiation as a passive source of electricity by making use of current and upgraded technologies and efficiencies, namely thin-film solar arrays which are readily flexible and, by which, are capable of completely surrounding a large vitrified cylinder containing High Level Nuclear Waste. Likewise, this invention also readily incorporates into the current storage regime of High Level Nuclear Waste and is readily applicable requiring no modifications to current storage modalities.

Without further analyses, the foregoing will so fully reveal the gist of this invention that those skilled in the art can by applying current knowledge thereto readily adapt it for various applications without omitting certain features which can constitute essential characteristics of the generic or specific aspects of this invention. Therefore, a more lengthy description is deemed unnecessary.

It is intended that various changes may be made in this invention in the practical development thereof, if desired. Such changes are comprehended within the meaning and range of equivalency of the following claims. The invention, therefore, is not to be restricted except as is necessitated by the prior art.

1. A device for converting nuclear waste radiation to electricity, comprising alternating layers of diagnostic x-ray intensifying screens affixed to thin-film flexible solar panels for a total of three layers.

2. Said device as recited in claim 1 wraps around a vitrified nuclear waste cylinder.

3. Said device, as recited in claim 1 and placed as recited in claim 2, receives radiation from the vitrified nuclear waste cylinder, thereby producing light through the irradiation of the diagnostic x-ray intensifying screens.

4. The device as recited in claim 3, wherein said light emitting intensifying screens surfaces are facing and affixed to thin-film solar cell panels representing zero distance between said components so that the light emitted from the surface of the intensifying screens directly impinges on the thin film solar panels.

5. The device as recited in claim 1 wherein a plurality of photocells affixed to said intensifying screens as a layered array comprising three layers and receiving said light thus generating electricity therefrom.

6. Said device as recited in claim 1 is enveloped in totality by a protective and flexible sheath.
